(19) United States
(12) Patent Application Publication
(10) Pub. No.: US 2024/0140800 A1
(43) Pub. Date: May 2, 2024

(54) NITROGEN-DOPED POROUS CARBON MATERIAL AND PREPARATION METHOD AND USE THEREOF

(71) Applicant: INSTIT. OF APPL. CHEM, JIANGXI ACADEMY OF SCIENCES, Nanchang (CN)

(72) Inventors: Jinsong Shi, Nanchang (CN); Hongmin Cui, Nanchang (CN); Jianguo Xu, Nanchang (CN); Nanfu Yan, Nanchang (CN); Yuewei Liu, Nanchang (CN); Jiyong Zou, Nanchang (CN); Li Zhang, Nanchang (CN)

(73) Assignee: INSTIT. OF APPL. CHEM, JIANGXI ACADEMY OF SCIENCES, Nanchang, JX (CN)

(21) Appl. No.: 18/317,040

(22) Filed: May 12, 2023

(30) Foreign Application Priority Data
Nov. 2, 2022 (CN) 202211359676.0

(51) Int. Cl. C01B 32/05; B01J 6/00; B01J 20/20

(52) U.S. Cl. CPC C01B 32/05; B01J 6/001; B01J 20/20; B01J 2220/4825; B01J 2220/4837; C01P 2002/54; C01P 2002/85; C01P 2004/03; C01P 2004/04; C01P 2006/12; C01P 2006/14

(57) ABSTRACT

The present disclosure relates to a nitrogen-doped porous carbon material and a preparation method and use thereof. In the present disclosure, the preparation method of a nitrogen-doped porous carbon material includes the following steps: conducting carbonization on a biomass material to obtain a carbon source; and mixing the carbon source with a potassium 4-aminobenzoate aqueous solution, and drying and conducting calcination in a protective atmosphere sequentially to obtain the nitrogen-doped porous carbon material. In the preparation method, the potassium 4-aminobenzoate is used as a nitrogen source as well as an activator for preparing the nitrogen-doped porous carbon material. Nitrogen doping is simultaneously completed during the activation, and the nitrogen-doped porous carbon material can be prepared through one-step calcination. The nitrogen-doped porous carbon material has relatively-high specific surface area and nitrogen content, and has an excellent CO₂ adsorption performance, which shows a high CO₂ adsorption capacity.

### CROSS REFERENCE TO RELATED APPLICATION

This patent application claims the benefit and priority of Chinese Patent Application No. 202211359676.0, filed with the China National Intellectual Property Administration on Nov. 2, 2022, the disclosure of which is incorporated by reference herein in its entirety as part of the present application.

### TECHNICAL FIELD

The present disclosure belongs to the technical field of porous carbon materials, and in particular relates to a nitrogen-doped porous carbon material and a preparation method and use thereof.

### BACKGROUND

Nitrogen-doped porous carbon materials have been widely used and studied in the fields of energy, environment, catalysis, and adsorption. Nitrogen-doped porous carbon materials are used as CO₂ adsorbents. The basic nitrogen-containing groups and micropores in these materials may affect the adsorption of CO₂.

The preparation of nitrogen-doped porous carbon materials mainly takes two aspects into consideration, namely porous structure and nitrogen doping. In order to achieve nitrogen doping in carbon materials, there are generally two methods. One is to use organic matters that contain nitrogen as a starting material. The other is to conduct post-treatment on the carbon materials with nitrogen-containing compounds such as ammonia at high temperatures. In addition, to form a well-developed porous structure in the carbon materials, chemical activation is the most commonly-used approach. The chemical activation mainly includes: conducting carbonization on a starting material to obtain a carbon source, uniformly mixing the carbon source with an activator, and then treating a resulting mixture at a high temperature. Currently, the most widely-used activators include potassium hydroxide, phosphoric acid, and zinc chloride. These activators are universal, but may corrode instruments and equipment to a certain extent at high temperatures due to their inherent corrosiveness.

Traditionally, the preparation of nitrogen-doped porous carbon materials requires different materials as the activator and nitrogen source, respectively. For example, Chinese patent CN110078046A disclosed a preparation method and use of a nitrogen-doped porous carbon material. In this technique, carbon dioxide is used as a physical activator. However, the physical activator itself does not have the function of nitrogen doping, and additional substances are required as a nitrogen source. Moreover, the prepared nitrogen-doped porous carbon material has a low carbon dioxide adsorption capacity.

### SUMMARY

In view of this, an objective of the present disclosure is to provide a nitrogen-doped porous carbon material and a preparation method and use thereof. In the present disclosure, the nitrogen-doped porous carbon material has a high specific surface area, a desirable nitrogen content, and an excellent carbon dioxide adsorption capacity.

To achieve the above objective, the present disclosure provides the following technical solutions:

The present disclosure provides a preparation method of a nitrogen-doped porous carbon material, including the following steps:
conducting carbonization on a biomass material to obtain a carbon source; and
mixing the carbon source with a potassium 4-aminobenzoate aqueous solution, and drying and conducting calcination in a protective atmosphere sequentially to obtain the nitrogen-doped porous carbon material.

Preferably, the carbon source and potassium 4-aminobenzoate in the potassium 4-aminobenzoate aqueous solution are at a mass ratio of 1:(1-5).

Preferably, the potassium 4-aminobenzoate and water in the potassium 4-aminobenzoate aqueous solution are at a mass ratio of 1:(5-20).

Preferably, the calcination is conducted at 600° C. to 900° C. for 1 h to 2 h.

Preferably, the preparation method further includes the following steps after the calcination is completed: washing and re-drying an obtained calcined product in sequence.

Preferably, the drying and the re-drying are conducted independently at 100° C. to 120° C. for 4 h to 6 h.

Preferably, the biomass material is one or more selected from the group consisting of chitosan, cellulose, agar, lignin, starch, gelatin, sucrose, and fructose.

Preferably, the carbonization includes hydrothermal carbonization or high-temperature carbonization;
the hydrothermal carbonization is conducted at 160° C. to 220° C. for 1 h to 6 h; and
the high-temperature carbonization is conducted at 400° C. to 600° C. for 1 h to 2 h.

The present disclosure further provides a nitrogen-doped porous carbon material prepared by the preparation method, where the nitrogen-doped porous carbon material has a specific surface area of 400 m²/g to 1,600 m²/g and a nitrogen content of 2 wt % to 6 wt %.

The present disclosure further provides use of the nitrogen-doped porous carbon material as a CO₂ adsorbent.

In the present disclosure, the preparation method of a nitrogen-doped porous carbon material includes the following steps: conducting carbonization on a biomass material to obtain a carbon source; and mixing the carbon source with a potassium 4-aminobenzoate aqueous solution, and drying and conducting calcination in a protective atmosphere sequentially to obtain the nitrogen-doped porous carbon material.

Compared with the prior art, the present disclosure has the following beneficial effects:

In the preparation method, the potassium 4-aminobenzoate is used as a nitrogen source as well as an activator for preparing the nitrogen-doped porous carbon material. Nitrogen doping is simultaneously completed during the activation, and the nitrogen-doped porous carbon material can be prepared through one-step calcination. The nitrogen-doped porous carbon material has relatively-high specific surface area and nitrogen content, and has an excellent CO₂ adsorption performance, which shows a high CO₂ adsorption capacity. However, traditional activators such as potassium hydroxide and phosphoric acid do not contain nitrogen and can only form porous structures after activation. Nitrogen doping can only be achieved by adding other compounds for further treatments.

Further, compared with the preparation of nitrogen-doped porous carbon materials by traditional step-by-step calcination, the nitrogen-doped porous carbon material can be prepared by one-step calcination in the present disclosure. In this way, the preparation method is simplified to realize a higher efficiency. Moreover, compared with conventional chemical activators such as potassium hydroxide, the potassium 4-aminobenzoate of the present disclosure is safe and non-corrosive, which is friendly to instruments and equipment.

The present disclosure further provides a nitrogen-doped porous carbon material prepared by the preparation method, and use of the nitrogen-doped porous carbon material in carbon dioxide adsorption. In the present disclosure, the nitrogen-doped porous carbon material has a high specific surface area of 400 m²/g to 1600 m²/g, a desirable nitrogen content of 2 wt % to 6 wt %, and an excellent carbon dioxide adsorption capacity of 2.42 mmol/g to 4.38 mmol/g.

### BRIEF DESCRIPTION OF THE DRAWINGS

To describe the technical solutions in the examples of the present disclosure or in the prior art more clearly, the accompanying drawings required for the examples are briefly described below. Apparently, the accompanying drawings in the following description show merely some examples of the present disclosure, and those of ordinary skill in the art may still derive other accompanying drawings from these accompanying drawings without creative efforts.

FIG. 1 shows a scanning electron microscopy (SEM) photo of a nitrogen-doped porous carbon material prepared in Example 1;

FIG. 2 shows a transmission electron microscopy (TEM) photo of the nitrogen-doped porous carbon material prepared in Example 1;

FIG. 3A-3C show X-ray photoelectron spectroscopy (XPS)-based test characterization pattern of nitrogen in the nitrogen-doped porous carbon materials prepared in Examples 1 to 3;

FIG. 4 shows a nitrogen absorption-desorption test result of the nitrogen-doped porous carbon materials prepared in Examples 1 to 3; and

FIG. 5 shows a test results of a CO₂ adsorption capacity.

### DETAILED DESCRIPTION OF THE EMBODIMENTS

The present disclosure provides a preparation method of a nitrogen-doped porous carbon material, including the following steps:
conducting carbonization on a biomass material to obtain a carbon source; and
mixing the carbon source with a potassium 4-aminobenzoate aqueous solution, and drying and conducting calcination in a protective atmosphere sequentially to obtain the nitrogen-doped porous carbon material.

In the present disclosure, unless otherwise specified, all materials and equipment used are commercially available items in the art.

In the present disclosure, carbonization is conducted on a biomass material to obtain a carbon source.

In the present disclosure, the biomass material is preferably one or more selected from the group consisting of chitosan, cellulose, agar, lignin, starch, gelatin, sucrose, and fructose.

In the present disclosure, the carbonization includes preferably hydrothermal carbonization or high-temperature carbonization.

In the present disclosure, the hydrothermal carbonization is conducted at preferably 160° C. to 220° C., more preferably 180° C. to 210° C. for preferably 1 h to 6 h, more preferably 5 h to 6 h.

In the present disclosure, during the hydrothermal carbonization, water and the biomass material are at a dosage ratio of preferably 100 mL:(5-20) g, more preferably 100 mL:10 g.

In the present disclosure, when the carbonization is preferably the hydrothermal carbonization, the preparation method further includes preferably: subjecting a hydrothermal carbonization feed solution obtained after the hydrothermal carbonization to first filtration, first washing, and first drying in sequence to obtain the carbon source.

In the present disclosure, there is no special requirement for the first filtration, and a method commonly used by those skilled in the art can be used.

In the present disclosure, the first washing is conducted preferably by water, and the water is preferably distilled water; and the first washing is conducted preferably 2 to 3 times, more preferably 3 times.

In the present disclosure, the first drying is conducted at preferably 100° C. to 120° C., more preferably 100° C. to 110° C. for preferably 4 h to 6 h, more preferably 4 h. The first drying can remove moisture in a product obtained from the first washing.

In the present disclosure, the high-temperature carbonization is conducted at preferably 400° C. to 600° C., more preferably 500° C. to 550° C. for preferably 1 h to 2 h, more preferably 1.5 h to 2 h. The high-temperature carbonization temperature is achieved by heating at preferably 5° C./min to 15° C./min, more preferably 10° C./min.

In the present disclosure, the high-temperature carbonization is conducted preferably under a protective atmosphere, and the protective atmosphere is preferably nitrogen or argon. The high-temperature carbonization is conducted preferably in a tubular furnace. The nitrogen or argon is introduced into the tubular furnace at preferably 60 mL/min.

In the present disclosure, when the carbonization is preferably the high-temperature carbonization, the preparation method further includes preferably: conducting first cooling to obtain the carbon source, where the first cooling is preferably natural cooling, to reach preferably a room temperature.

In the present disclosure, the carbon source is mixed with a potassium 4-aminobenzoate aqueous solution, and dried and calcination is conducted in a protective atmosphere sequentially to obtain the nitrogen-doped porous carbon material.

In the present disclosure, the potassium 4-aminobenzoate aqueous solution has potassium 4-aminobenzoate and water at a mass ratio of preferably 1:(5-20), more preferably 1:(10-15).

In the present disclosure, the carbon source and the potassium 4-aminobenzoate in the potassium 4-aminobenzoate aqueous solution are at a mass ratio of preferably 1:(1-5), more preferably 1:(3-4).

In the present disclosure, there is no special limitation on a preparation method of the potassium 4-aminobenzoate aqueous solution, and the preparation method of a solution well known to those skilled in the art can be used.

In the present disclosure, the mixing is conducted at preferably 20° C. to 30° C., more preferably 25° C. to 30° C. In a specific example, the room temperature is used.

In the present disclosure, the drying is conducted at preferably 100° C. to 120° C., more preferably 100° C. to 110° C. for preferably 4 h to 6 h, more preferably 5 h.

In the present disclosure, the calcination is conducted at preferably 600° C. to 900° C., more preferably 700° C. to 800° C. for preferably 1 h to 2 h. The calcination temperature is achieved by heating at preferably 1° C./min to 15° C./min, more preferably 5° C./min to 10° C./min.

In the present disclosure, the protective atmosphere is preferably nitrogen or argon. The calcination is conducted preferably in a tubular furnace. The calcination preferably includes: continuously introducing the protective atmosphere into the tubular furnace. The protective atmosphere is introduced into the tubular furnace at preferably 60 mL/min.

In the present disclosure, the preparation method further includes preferably the following steps after the calcination is completed: washing and re-drying an obtained calcined product in sequence.

In the present disclosure, the calcined product is preferably washed after cooling. The calcined product is preferably naturally cooled, to achieve preferably a room temperature.

In the present disclosure, the washing includes preferably acid pickling and water washing in sequence. The acid pickling is conducted with preferably an aqueous strong acid solution, which includes preferably a hydrochloric acid solution. The hydrochloric acid solution has a concentration of preferably 5 wt % to 20 wt %, more preferably 10 wt %. There is no special requirement on the number of times of the water washing, and a solution obtained after the water washing has a pH value of preferably 7.0.

In the present disclosure, the re-drying is conducted at preferably 100° C. to 120° C., more preferably 100° C. to 110° C. for preferably 4 h to 6 h, more preferably 5 h.

The present disclosure further provides a nitrogen-doped porous carbon material prepared by the preparation method, where the nitrogen-doped porous carbon material has a specific surface area of 400 m²/g to 1,600 m²/g and a nitrogen content of 2 wt % to 6 wt %.

In the present disclosure, the nitrogen-doped porous carbon material has a specific surface area of preferably 1,086 m²/g to 1,547 m²/g.

In the present disclosure, the nitrogen-doped porous carbon material has a nitrogen content of preferably 2.83 wt % to 5.65 wt %.

The present disclosure further provides use of the nitrogen-doped porous carbon material as a CO₂ adsorbent.

In the present disclosure, the use is conducted preferably at 25° C. and a pressure of 1 bar to 1.1 bar.

In the present disclosure, the nitrogen-doped porous carbon material has a high carbon dioxide adsorption capacity of 2.42 mmol/g to 4.38 mmol/g.

To further illustrate the present disclosure, the nitrogen-doped porous carbon material and the preparation method and the use thereof provided in the present disclosure are described in detail below with reference to examples, but the examples should not be interpreted as a limitation to the protection scope of the present disclosure.

### Example 1

A starch was placed in a tubular furnace. Under the protection of nitrogen (60 mL/min), a furnace temperature was raised to 550° C. at 10° C./min, and the starch was subjected to high-temperature carbonization for 2 h, and then naturally cooled to a room temperature to obtain a carbon source.

1.0 g of potassium 4-aminobenzoate was dissolved in 15 mL of deionized water to form a transparent solution, 1.0 g of the carbon source was added, stirred at a room temperature for 2 h, and a resulting mixture was dried at 100° C. for 5 h. A dried mixture (the carbon source and the potassium 4-aminobenzoate) was placed in the tubular furnace under nitrogen protection (introducing at 60 mL/min). The tubular furnace temperature was raised from the room temperature to 600° C. at 10° C./min and then held for 1 h. After natural cooling, an obtained product was washed with 10 wt % hydrochloric acid, washed repeatedly with deionized water, and then dried at 100° C. for 4 h to obtain a nitrogen-doped porous carbon material.

### Example 2

5.0 g of sucrose was dissolved in 50 mL of water to form a transparent solution, which is placed in a 100 mL stainless steel hydrothermal reactor, and then subjected to hydrothermal carbonization at 200° C. for 5 h. An obtained product was filtered, washed repeatedly with deionized water, and then dried at 100° C. for 4 h to obtain a carbon source.

1.0 g of potassium 4-aminobenzoate was dissolved in 15 mL of deionized water to form a transparent solution, 1.0 g of the carbon source was added, stirred at a room temperature for 2 h, and a resulting mixture was dried at 100° C. for 5 h. A dried mixture (the carbon source and the potassium 4-aminobenzoate) was placed in the tubular furnace under nitrogen protection (introducing at 60 mL/min). The tubular furnace temperature was raised from the room temperature to 700° C. at 10° C./min and then held for 2 h. After natural cooling, an obtained product was washed with 10 wt % hydrochloric acid, washed repeatedly with deionized water, and then dried at 100° C. for 4 h to obtain a nitrogen-doped porous carbon material.

### Example 3

5.0 g of sucrose was dissolved in 50 mL of water to form a transparent solution, which is placed in a 100 mL stainless steel hydrothermal reactor, and then subjected to hydrothermal carbonization at 200° C. for 5 h. An obtained product was filtered, washed repeatedly with deionized water, and then dried at 100° C. for 4 h to obtain a carbon source.

3.0 g of potassium 4-aminobenzoate was dissolved in 15 mL of deionized water to form a transparent solution, 1.0 g of the carbon source was added, stirred at a room temperature for 2 h, and a resulting mixture was dried at 100° C. for 5 h. A dried mixture (the carbon source and the potassium 4-aminobenzoate) was placed in the tubular furnace under nitrogen protection (introducing at 60 mL/min). The tubular furnace temperature was raised from the room temperature to 800° C. at 10° C./min and then held for 2 h. After natural cooling, an obtained product was washed with 10 wt % hydrochloric acid, washed repeatedly with deionized water, and then dried at 100° C. for 4 h to obtain a nitrogen-doped porous carbon material.

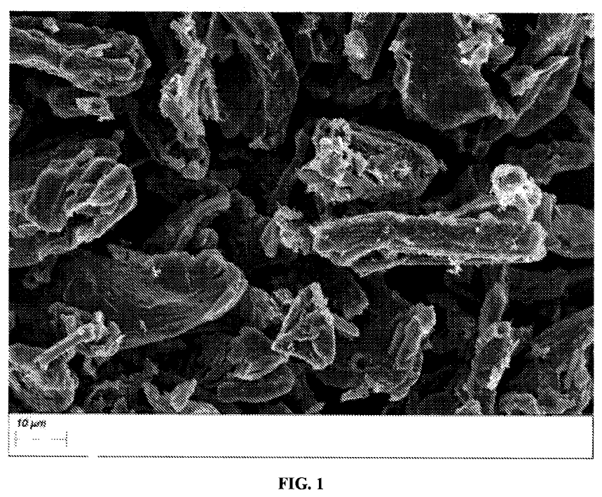

FIG. 1 showed a SEM photo of the nitrogen-doped porous carbon material prepared in Example 1. The nitrogen-doped porous carbon material prepared from the starch serving as a starting material exhibited a fragment-like irregular appearance.

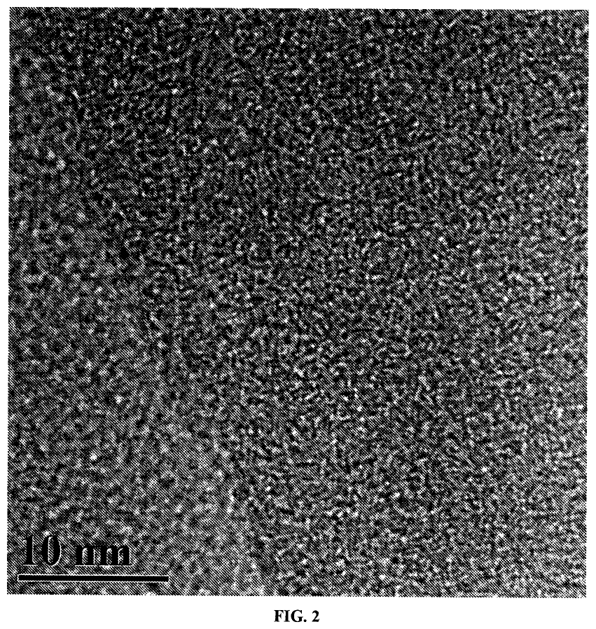

FIG. 2 showed a TEM photo of the nitrogen-doped porous carbon material prepared in Example 1. A large number of micropores were formed in the material, proving that the potassium 4-aminobenzoate could activate the carbon material at high temperatures, thereby forming a well-developed porous structure.

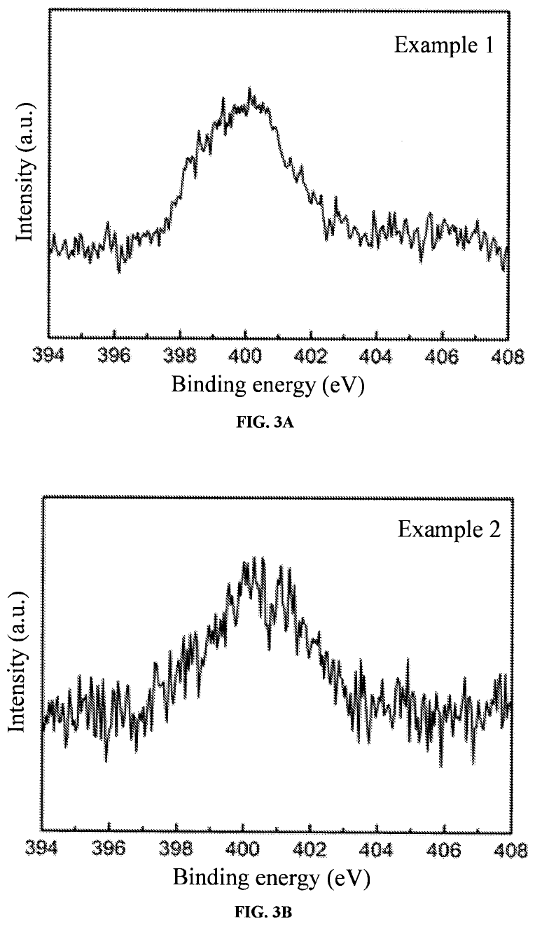

Nitrogen in the nitrogen-doped porous carbon materials prepared in Examples 1 to 3 was characterized by an XPS test, and the test results were shown in FIG. 3A-C. The results indicated that nitrogen doping was successfully achieved in the carbon material after activation with the potassium 4-aminobenzoate. The nitrogen-doped porous carbon materials prepared in Examples 1 to 3 had nitrogen contents of 5.65 wt %, 2.77 wt %, and 2.83 wt %, respectively.

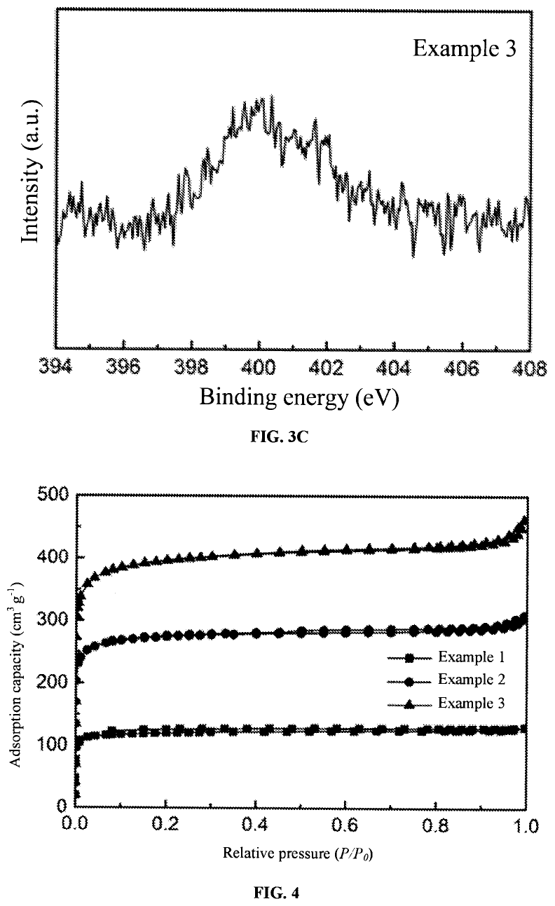

Nitrogen adsorption-desorption tests were conducted on the nitrogen-doped porous carbon materials prepared in Examples 1 to 3. A test method was static volume adsorption, and the test results were shown in FIG. 4. It was seen from FIG. 4 that after the activation by potassium 4-aminobenzoate, a well-developed porous structure was formed in each of the porous carbon materials prepared from different biomass materials. This was consistent with the features shown in the TEM photo of FIG. 2. The nitrogen-doped porous carbon materials prepared in Examples 1 to 3 had specific surface areas of 483 m²/g, 1,086 m²/g, and 1,547 m²/g, respectively.

Carbon dioxide adsorption characteristics were tested for the nitrogen-doped porous carbon materials prepared in Examples 1 to 3. A test method included the following steps:
1) 100 mg of the nitrogen-doped porous carbon material was added into a test sample chamber, and heated to 250° C. to conduct vacuum degassing for 3 h;
2) an ambient temperature of the test sample chamber was set, and a carbon dioxide pressure gradually increased from a vacuum state; an adsorption capacity at each equilibrium pressure was measured until the equilibrium pressure reached 1.0 bar to obtain a complete carbon dioxide adsorption isotherm; and
3) after the carbon dioxide adsorption test was completed, the test sample chamber was heated to 100° C. for vacuum treatment to complete the carbon dioxide desorption.

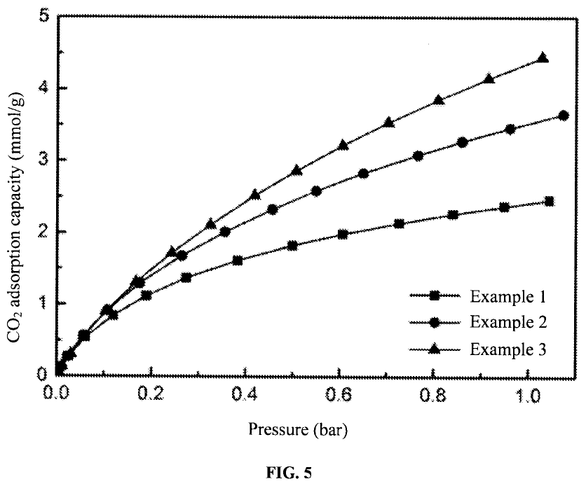

The CO₂ adsorption test results were shown in FIG. 5. It was seen from FIG. 5 that under 25° C. and at a 1 bar pressure, the nitrogen-doped porous carbon materials prepared in Examples 1 to 3 had CO₂ adsorption capacities of 2.42 mmol/g, 3.53 mmol/g, and 4.38 mmol/g, respectively. With the increase of calcination temperature and the addition of potassium 4-aminobenzoate, the CO₂ adsorption capacity increased gradually. The nitrogen-doped porous carbon material prepared in Example 3 had a CO₂ adsorption capacity of 4.38 mmol/g. The above test results showed that the nitrogen-doped porous carbon material with an excellent CO 2 adsorption performance was synthesized using the biomass material as a carbon source and the potassium 4-aminobenzoate as an activator as well as a nitrogen source.

Although the above example has described the present disclosure in detail, it is only a part of, not all of, the examples of the present disclosure. Other examples may also be obtained by persons based on the example without creative efforts, and all of these examples shall fall within the protection scope of the present disclosure.

What is claimed is:

1. A preparation method of a nitrogen-doped porous carbon material, comprising the following steps:
conducting carbonization on a biomass material to obtain a carbon source; and
mixing the carbon source with a potassium 4-aminobenzoate aqueous solution, and drying and conducting calcination in a protective atmosphere sequentially to obtain the nitrogen-doped porous carbon material.

2. The preparation method according to claim 1, wherein the carbon source and potassium 4-aminobenzoate in the potassium 4-aminobenzoate aqueous solution are at a mass ratio of 1:(1-5).

3. The preparation method according to claim 1, wherein the potassium 4-aminobenzoate and water in the potassium 4-aminobenzoate aqueous solution are at a mass ratio of 1:(5-20).

4. The preparation method according to claim 2, wherein the potassium 4-aminobenzoate and water in the potassium 4-aminobenzoate aqueous solution are at a mass ratio of 1:(5-20).

5. The preparation method according to claim 1, wherein the calcination is conducted at 600° C. to 900° C. for 1 h to 2 h.

6. The preparation method according to claim 1, further comprising the following steps after the calcination is completed: washing and re-drying an obtained calcined product in sequence.

7. The preparation method according to claim 5, further comprising the following steps after the calcination is completed: washing and re-drying an obtained calcined product in sequence.

8. The preparation method according to claim 6, wherein the drying and the re-drying are conducted independently at 100° C. to 120° C. for 4 h to 6 h.

9. The preparation method according to claim 7, wherein the drying and the re-drying are conducted independently at 100° C. to 120° C. for 4 h to 6 h.

10. The preparation method according to claim 1, wherein the biomass material is one or more selected from the group consisting of chitosan, cellulose, agar, lignin, starch, gelatin, sucrose, and fructose.

11. The preparation method according to claim 1, wherein the carbonization comprises hydrothermal carbonization or high-temperature carbonization;
the hydrothermal carbonization is conducted at 160° C. to 220° C. for 1 h to 6 h; and
the high-temperature carbonization is conducted at 400° C. to 600° C. for 1 h to 2 h.

12. The preparation method according to claim 10, wherein the carbonization comprises hydrothermal carbonization or high-temperature carbonization;
the hydrothermal carbonization is conducted at 160° C. to 220° C. for 1 h to 6 h; and
the high-temperature carbonization is conducted at 400° C. to 600° C. for 1 h to 2 h.

13. A nitrogen-doped porous carbon material prepared by the preparation method according to claim 1, wherein the nitrogen-doped porous carbon material has a specific surface area of 400 m²/g to 1,600 m²/g and a nitrogen content of 2 wt % to 6 wt %.

14. The nitrogen-doped porous carbon material according to claim 13, wherein the carbon source and potassium 4-aminobenzoate in the potassium 4-aminobenzoate aqueous solution are at a mass ratio of 1:(1-5).

15. The nitrogen-doped porous carbon material according to claim 13, wherein the potassium 4-aminobenzoate and water in the potassium 4-aminobenzoate aqueous solution are at a mass ratio of 1:(5-20).

16. The nitrogen-doped porous carbon material according to claim 13, wherein the calcination is conducted at 600° C. to 900° C. for 1 h to 2 h.

17. The nitrogen-doped porous carbon material according to claim 13, further comprising the following steps after the calcination is completed: washing and re-drying an obtained calcined product in sequence.

18. The nitrogen-doped porous carbon material according to claim 17, wherein the drying and the re-drying are conducted independently at 100° C. to 120° C. for 4 h to 6 h.

19. The nitrogen-doped porous carbon material according to claim 13, wherein the biomass material is one or more selected from the group consisting of chitosan, cellulose, agar, lignin, starch, gelatin, sucrose, and fructose.

20. A CO₂ adsorbent prepared by the nitrogen-doped porous carbon material according to claim 13.
